(19) United States
(12) Patent Application Publication
(10) Pub. No.: US 2019/0336912 A1
(43) Pub. Date: Nov. 7, 2019

(54) PHOSPHATE ROCK SCRUBBING OF A SULFUR DIXOIDE GAS STREAM

(71) Applicant: CLARK SOLUTIONS LLC, BOCA RATON, FL (US)

(72) Inventor: Brian M. Burmaster, Cologne (DE)

(73) Assignee: CLARK SOLUTIONS LLC, BOCA RATON, FL (US)

(21) Appl. No.: 16/384,503

(22) Filed: Apr. 15, 2019

Related U.S. Application Data
(60) Provisional application No. 62/661,433, filed on Apr. 23, 2018.

(51) Int. Cl. B01D 53/50; B01D 53/80; B01D 53/96; C01B 17/04

(52) U.S. Cl. CPC B01D 53/507; B01D 53/80; B01D 2257/302; C01B 17/0404; B01D 2251/61; B01D 53/96

(57) ABSTRACT

This application is directed to the field of scrubbing a sulfur dioxide-laden gas stream by a phosphate rock solution, and then regenerating that sulfur dioxide gas via acidulation, by contacting the phosphate rock solution with sulfuric acid to regenerate a high purity sulfur dioxide stream.

### CROSS REFERENCE TO RELATED APPLICATIONS

This application claims the benefit of U.S. Application No. 62/661,433, filed Apr. 23, 2018. The contents of U.S. Application No. 62/661,433, filed Apr. 23, 2018 are incorporated by reference in its entirety.

### FIELD OF INVENTION

This application is directed to the field of scrubbing a sulfur dioxide-laden gas stream by a phosphate rock solution, and then regenerating that sulfur dioxide gas via acidulation, by contacting the phosphate rock solution with sulfuric acid to regenerate a high purity sulfur dioxide stream.

### BACKGROUND OF INVENTION

Since the passage of the Clean Air Act in 1973, the United States Environmental Protection Agency has mandated sulfur dioxide conversion levels of 99.7% (or 4 pounds of sulfur dioxide emitted per Short Ton of sulfuric acid produced). A typical flow diagram showing all the gas-side equipment for a Double Contact Double Absorption (DC/DA) sulfuric acid plant is shown in Figure One, employing a 3/1 system, meaning that there are three converter passes prior to the first or Interpass Absorber and 1 final converter pass along with the Final Absorption Tower. The DC/DA process for sulfuric acid is known as the Bayer process when U.S. Pat. No. 3,259,459 was granted. The conversion of sulfur dioxide to sulfuric acid is limited by the equilibrium catalytic temperature that is set by the exiting process conditions from the converter from the adiabatic temperature rise of the oxidative exothermic reaction of sulfur dioxide. An example of the temperature dependency is shown in Figure Two. For 40+ years, this standard in sulfur dioxide level and the DC/DA sulfuric acid process has been accepted worldwide. This invention has the following objectives:
1. Lower sulfur dioxide gas emissions
2. Higher sulfuric acid production
3. Greater energy efficiency through lower pressure drop
4. Reduced level of capital investment

All these mutual objectives are met with this novel invention and is specifically targeted for the biggest producers of sulfuric acid, that being the phosphate fertilizer industry. The starting material for fertilizer, the phosphate rock solution exists in the pH range, according to many laboratory tests showing that the pH solution is much greater than 8, which according to the well-known Johnstone pH curve (see Figure Three) where almost all of the gaseous sulfur dioxide stream is dissolved completely in the aqueous media and thereby capturing 99.99+% of this sulfur-dioxide species as either sulfite (SO₃^{═}) or bi-sulfite (H SO₃^{═}) anions.

A sulfur dioxide-enriched stream can be generated quite easily by acidulation whereby the phosphate rock solution is contacted with concentrated sulfuric acid, thereby lowering the pH and ensuring all the sulfite (SO₃^{═}) or bi-sulfite (H SO₃^{═}) anions are converted to purified and concentrated sulfur dioxide gas. This very pure sulfur dioxide gas can then be introduced to a typical sulfuric acid plant or other industrial processes that require SO₂ as a feedstock.

### SUMMARY OF INVENTION

Although the patent literature is full of examples whereby either an inorganic or organic base is used to scrub a gas stream and thereby achieving extremely low levels of sulfur dioxide, the simple fact is that regeneration is difficult and/or very costly. This industrial reality is evidenced in the two biggest phosphate fertilizer complexes in the world, as reported by Sulfuric Acid Today, and shown in Table One below:

TABLE ONE
TWO BIGGEST PHOSPHATE FERTILIZER PLANTS
WORLDWIDE

| | | | Number | | |
|---|---|---|---|---|---|
| | | H₂SO₄ | of Acid | Process | SO₂ |
| Company | Location | MTPD | Plants | Technology | Efficiency |
| OCP | Agadir, | 14 420 | 6 | 3/1 DA DC | 99.7% |
| | Morocco | | | | |
| Mosaic | Riverview, | 8 440 | 3 | 3/1 DA DC | 99.7% |
| | FL USA | | | | |

The process technology utilized by the two biggest phosphate fertilizer plants in the world is reported as 3/1 DA DC or three converter passes before the Interpass Absorber and one converter pass after the Interpass Absorber, thus the 3/1 DA (Double Absorption) and DC (Double Contact) designation. Very little has changed in sulfuric acid technology dedicated to phosphate fertilizer from the 1960 German patent filing by Wilhelm Muller with his Bayer process that is described in U.S. Pat. No. 3,259,459. Present industrial practice is consistent with the expected conversion being 99.7%, as Muller reported in his third example (column 5 line 31). The only difference is that the Bayer process employed a 2/1 DA DC scheme (two converter passes prior to the Interpass Absorber), while modern plants are designed with a 3/1 DA DC process.

The patent literature is replete with allegedly regenerative sulfur dioxide scrubbing systems. The basic underlying assumption of these caustic scrubbing system is the well-known Johnstone curve, which is shown in Figure Three, displaying the various species of sulfur dioxide, bi-sulfite (HSO₃⁻) and sulfite (SO₃^{═}) as function of the solution pH. The Wellman-Lord system, as described in Miller's U.S. Pat. No. 3,477,815 with a sodium sulfite (SO₃^{═}) and sodium bi-sulfite (HSO₃⁻) scrubbing solution system and thermal regeneration is a good working industrial example.

More recent examples are found in the patent literature and have been marketed industrially as the UCAP™ (Union Carbide Amine Process) system, as disclosed by Atwood in U.S. Pat. No. 3,904,735 or Hakka's amine Cansolv™ system as described in U.S. Pat. No. 5,019,361 In a similar vein, organic physical solvents such as Linde's Clintox™ (tetraethylene glycol dimethyl ether) or the ClausMaster™ (Dibutyl butyl phosphonate) solvents although they do not follow the Johnstone pH curve; they have common process attributes. All these inorganic, amine and organic physical absorption systems require thermal regeneration, and this very essential requirement is extremely problematic, causing unwanted heat stable salt formations, which accumulates in the scrubbing solution and therefore needs to be removed, usually by ion exchange. These absorption-regeneration solvent cycle systems are very similar and the general process flow diagram is shown in Figure Four.

It should be appreciated that the Johnstone curve is a simplifications and rough approximations of the complex chemistry of sulfur dioxide, especially in aqueous media. Johnstone assumed only three sulfur species (sulfur dioxide [SO₂], bi-sulfite [HSO₃⁻] and sulfite [SO₃^{═}]). For a more accurate picture of all these complications, an excellent article entitled “Fundamental Chemistry of Sulfur Dioxide Removal and Subsequent Recovery via Aqueous Scrubbing” by Dr. Max Schmidt of the Institut fur Anorganiche Chemie der Universitat Wurzburg and published in International Journal of Sulfur Chemistry; Part B; Volume 7; pages 11-19 highlights the pitfalls of sulfur dioxide regeneration. Dr. Schmidt teaches us the very important fundamental principle that in all aqueous media (such as the phosphate rock solution), sulfur can exist in various valence states, but only the sulfur dioxide species is not stable:

TABLE TWO
Valence States of Sulfur Molecules

| | Chemical | Elemental | Aqueous |
|---|---|---|---|
| Valence | Species | Form | State |
| −2 | Sulfides | H₂S | Stable |
| 0 | Sulfur | S | Stable |
| +4 | Sulfur | SO₂ | Meta-stable |
| | Dioxide | | |
| +6 | Sulfates | SO₄ | Stable |

This basic and inherent problem with aqueous sulfur-dioxide media ultimately leads to the destructive creation of tremendous quantities of unwanted salts in the sulfur-dioxide laden liquid stream, necessitating their removal. Thus, all these scrubbing processes which employ aqueous agents (such as Wellman-Lord, UCAP or Cansolv™) which capture fugitive gaseous SO₂ emissions suffer from Dr. Max Schmidt's principle of meta-stability, meaning that these various salt forms must be removed by either ion exchange, electrodialysis or other processes, which result in lost solvent, whether that media is organic, such as the UCAP or Cansolv™ amine solutions or the Wellman-Lord inorganic sodium aqueous solution.

Unfortunately, there is very little data on heat stable salt (HSS) formation in aqueous media used to capture sulfur dioxide. One notable exception is Kosseim's (part of the UCAP team) U.S. Pat. No. 4,201,752 that gave this data with two different amines (Monoethanolamine—MEA and Triethanolamine—TEA) at a couple of different process temperatures (40° C. and 90° C.). Kosseim's data is reproduced in Table Three:

TABLE THREE
Heat Stable Salt (HSS) Formation Rates
in Aqueous Amine Solutions

| Amine | Temperature | % Oxygen | HSS Rate |
|---|---|---|---|
| MEA | 40° C. | 5.0 | 0.03% hr⁻¹ |
| MEA | 90° C. | 0.0 | 0.11% hr⁻¹ |
| TEA | 40° C. | 5.0 | 0.01% hr⁻¹ |
| TEA | 90° C. | 0.0 | 0.89% hr⁻¹ |

Clearly, heat stable salt formation (HSS) is highly temperature-dependent, as expected, with lower temperatures drastically reducing the amount of HSS formation. It should be noted that as shown in Figure Four, the phosphate rock aqueous solution is contacting the bone-dry gas stream exiting the sulfuric acid plant and will be massively cooled to a much colder temperature than Kosseim's 40° C., with computed adiabatic temperatures in the range of 15° C. to 30° C. Thus, HSS formation rates, which Dr. Schmidt identifies correctly as sulfur dioxide disproportionation rate will be significantly lower than the 40° C. data.

Another very good point made in Dr. Schmidt's article (Section IX—Alternate Stripping Agents page 17) is “A logical solution to the inherent problem would be to find and use a buffer solution other than (HSO₃⁻/SO₃^{═}) that cannot undergo disproportionation or oxidation reactions. A very careful theoretical and experimental study should be made from this point of view. A phosphate system (H₂PO₄⁻/HPO₃^{═}) seems to satisfy the requirement . . . ” To the best of my knowledge, no such aqueous phosphate data exists, but physical organic solvent data does exist, which employed Linde AG's Solinox™ solvent (tetraethylene glycol dimethyl ether or Tetraglyme) versus the ClausMaster™ solvent of Dibutyl, butyl phosphonate (DBBP). That data is shown in Table Four:

TABLE FOUR
Heat Stable Salt (HSS) Formation Rates in Organic Solvents

| Process | Temperature | Oxygen | HSS Rate |
|---|---|---|---|
| Solinox ™ | 100° C. | 0.0% | 0.00621% hr⁻¹ |
| ClausMaster ™ | 98° C. | 20.9% | 0.00082% hr⁻¹ |

Both sets of data are not from a laboratory environment but industrial settings. Linde's Solinox™ system with the tetraethylene glycol dimethyl ether is described by Heisel et. al. in U.S. Pat. No. 4,795,620 and the solvent decomposition rate emanated from a full-scale physical absorption system. Steam and vacuum were used to regenerate the solvent and remove sulfur dioxide. The data from the ClausMaster™ system comes from the pilot plant that was operated at Big River Zinc (a smelter rich SO₂ gas of ˜7% was fed into the absorber and hot air was used to strip the sulfur dioxide from the DBBP solvent). Thus, the ClausMaster™ solvent experienced the most aggressive oxidizing conditions and yet had the lowest solvent decomposition rates, validating Dr. Schmidt's statement about employing a fully oxidized pentavalent phosphorous solvent, as a carrier. The ClausMaster™ process is described in U.S. Pat. No. 5,851,265 by Burmaster et. al.

This invention uses all these teachings by using the phosphate rock solution as the scrubbing agent to capture odious sulfur dioxide from the gas stream, as shown in Figure Five of the phosphate rock solution (PRS) scrubber, which shows the equipment needed to capture the fugitive sulfur dioxide gas stream with fresh PRS entering the system and the SO₂-laden phosphate rock solution leaving the scrubber system. Typically, the fresh PRS solution is added by level control while the spent PRS solution leaves the scrubber system for further processing in the acidulation process.

A very rich SO₂ gas stream (>95+ mole %) is produced which contains an amount of water vapor in equilibrium with the aqueous phosphate rock media. The high-purity SO₂ gas still needs to be desiccated in a small SO₂ Drying Tower and compressed with a small SO₂ blower which boosts the gas pressure to the operating conditions of the first converter pass where the SO₂ is converted to SO₃. The process only needs 2 catalytic beds for conversion, since the phosphate rock solution can absorb fugitive SO₂ from the gas stream.

Initial process simulations show that this novel disclosure can meet all the objectives given in the prior section. Table Five shows the simulated results:

TABLE FIVE
Simulation of 2/0 PRS Process vs Standard 3/1 IPA Process

| Objective | Units | 3/1 IPA | 2/0 PRS |
|---|---|---|---|
| SO₂ Emission | ppmv | 400 | <10 |
| H₂SO₄ Rate | 3/1 IPA = 100 | 100 | 190 |
| Energy dP Usage | 3/1 IPA = 100 | 100 | 60 |
| Capital | 3/1 IPA = 100 | 100 | 1 |
| Investment | | | |

Thus, the objectives that were set out in the prior section are clearly met with the 2/0 Phosphate Rock Solution process as simulated by computer models and they greatly exceed the performance of the standard 3/1 Interpass process, which is presently employed in the two biggest phosphate fertilizer complexes in the world, that being OCP in Morocco and Mosaic in Florida.

### PREFERRED EMBODIMENT

A phosphate rock solution with a pH>3 and preferably less than 10 to avoid unnecessary carbon dioxide pickup is added in a scrubber circulating system with pumps, holding tanks, level indicators and the needed equipment to run a scrubber. Fresh phosphate rock solution is continually added to maintain this pH, as well known in the scrubbing industry. Level control continually draws off the sulfur dioxide enriched solution, which is fed into a Phosphate Rock Acidifier which is used in the phosphate fertilizer presently. The pH of that contactor is maintained at ˜1 to ensure that other stronger acids (such as the halides—chlorides. fluorides, and bromides) do not spring free. Any dissolved carbon dioxide will also be present with the sulfur dioxide stream, but this presents very little problem in contact sulfuric acid plants. The highly purified SO₂ enriched which is saturated with water vapor then enters a little SO₂ drying tower and blower which boosts the gas pressure to just beyond the operating pressure of the first pass of the catalytic converter system.

Actual pH of various Phosphate Rock Solution (PRS) in Brazil are displayed in Table Six shows clearly that the pH falls within this acceptable range.

TABLE SIX
Brazilian Phosphate Rock and Conductivity after 60 Minutes

| Rock Source | Sample ID | pH | Conductivity | |
|---|---|---|---|---|
| Uberaba | L-0260411 | 8.73 | 94.93 | us/cm |
| | L-0260412 | 8.49 | 94.70 | us/cm |
| Catalao | L-0260413 | 9.05 | 128.47 | us/cm |
| | L-0260414 | 8.18 | 134.50 | us/cm |

Figure Five shows the titration curves of these Brazilian phosphate when contacted with 0.05 Molar sulfuric acid solution. The starting pH of this solution is slightly lower than the data reported in Table Six since the solution contains less water at less contact time. However, the samples clearly show that the pH is within the acceptable range for scrubbing sulfur dioxide, since according to the Johnstone curve, there is expected to be no gaseous sulfur dioxide and only aqueous bi-sulfite (HSO₃⁻) ions or sulfite ions (SO₃^{═}). Finally, this titration curve shows that with careful addition of sulfuric acid, that the PRS (Phosphate Rock Solution) pH can be controlled to precise levels, meaning that if there are any dissolved halides (chlorides, fluorides . . . ) that they can be degassed precisely from the PRS in a controlled manner.

Figure Six is a simplified block flow diagram of the new Phosphate Rock Solution system, with the new process equipment shown within the dotted lines. The aqueous phosphate rock solution is fed into the phosphate rock scrubber where the sulfur dioxide-laden gas stream is contacted with this slightly alkaline solution, removing virtually all the sulfur dioxide from the gas stream in the form of aqueous sulfite or bi-sulfite ion. It should be remembered that with the exiting gas from a sulfuric acid plant is essentially bone-dry and thus, with this proposed system water leaves the system as a vapor.

The sulfite and bi-sulfite aqueous Phosphate Rock stream is fed via level control to the phosphate rock acidifier, along with sulfuric acid. This process step of acidifying phosphate rock is a necessary condition for present phosphate fertilizer producers, such as the biggest manufacturing plants of OCP in Morocco and Mosaic in Florida. However, unlike the present acidifiers, where the rock is acidified to much higher levels, with this system much lower levels of acidification are desired to spring the sulfur dioxide loose without liberation of halides. Thus, as shown in Figure Five showing the titration curve of a Phosphate Rock Solution, the pH can be carefully controlled.

Once the sulfur dioxide is liberated from the Phosphate Rock Solution, it will contain water vapor that is in equilibrium with the aqueous solution. To avoid potential problems with corrosion of downstream equipment, this gas stream must be dried in a little sulfur dioxide drying tower and then compressed via a sulfur dioxide blower to the gas pressure that is needed for the existing sulfuric acid plant's catalytic converter system. Both these pieces of equipment (SO₂ drying tower and SO₂ blower) are sized on the small amount of enriched (>90 mole %) sulfur dioxide which is recycled back to the sulfuric acid plant, which typically contains 10-12 mole % SO₂.

Alternately, the sulfur dioxide gas stream may come from a source other than a sulfuric acid plant. In this given example, phosphate rock could be shipped to a pollution source that is emitting unwanted sulfur dioxide to the atmosphere, such as a coal-fired electrical power plant. The Phosphate Rock Solution (PRS) that is laden with sulfur dioxide would then be shipped to a phosphate fertilizer company which would regenerate the sulfur dioxide by acidification, contacting the rock solution with sulfuric acid and that enriched sulfur dioxide gas stream would then be fed to their existing sulfuric acid plant.

Shipping phosphate rock very long distances is presently a commercial fact. For example, a little sulfuric acid plant located in Christchurch, New Zealand processing Moroccan phosphate rock in 2018. Thus, the economics of shipping sulfur dioxide-laden phosphate rock solution safely and processing PRS via the accompanying acidification as a feedstock to the phosphate fertilizer plant may dictate the financial feasibility of this process approach.

Additionally, the enriched and purified sulfur dioxide stream can also be introduced to other processes outside of sulfuric acid manufacturing facilities, such as Claus sulfur recovery plants (see for example, Michael Heisel's U.S. Pat. No. 5,439,664) or pulp-paper mills that may require this feedstock. Thus, there are many other possible processes which could use a highly purified sulfur dioxide stream, besides a sulfuric acid plant.

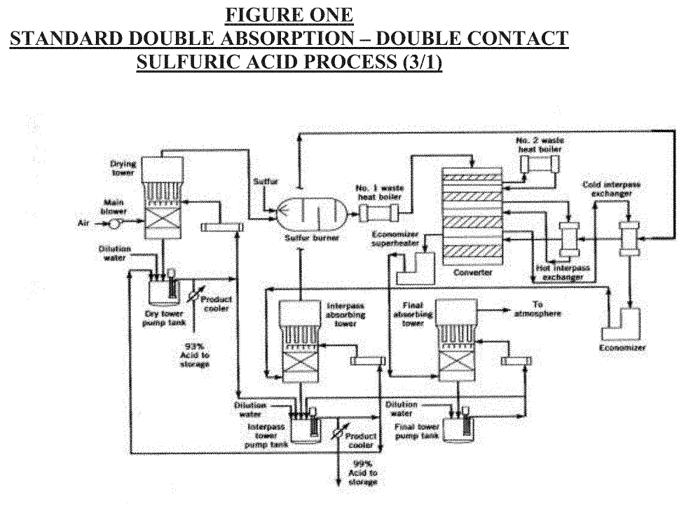

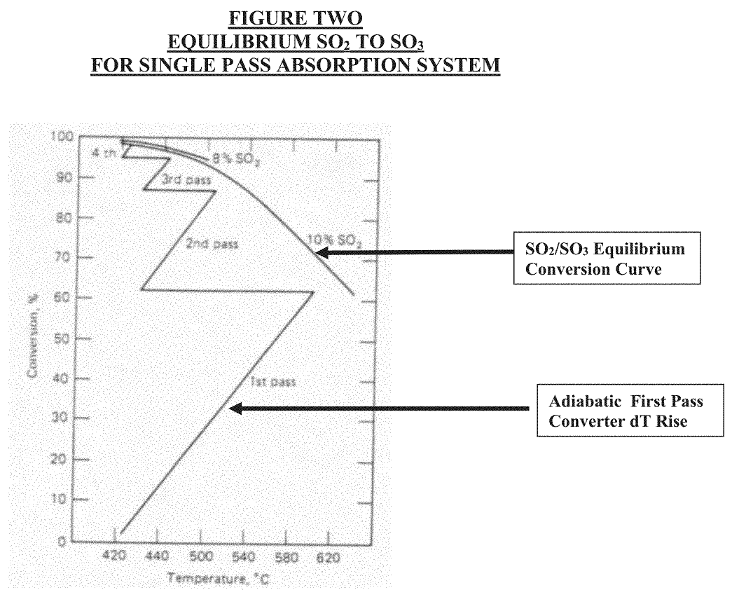

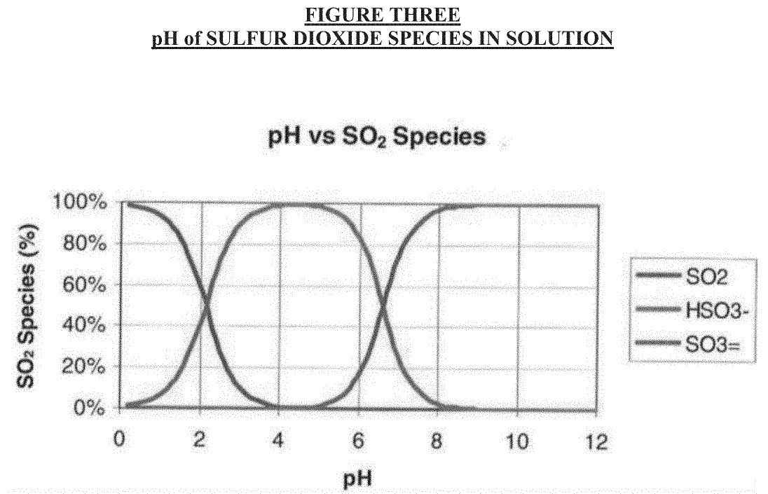

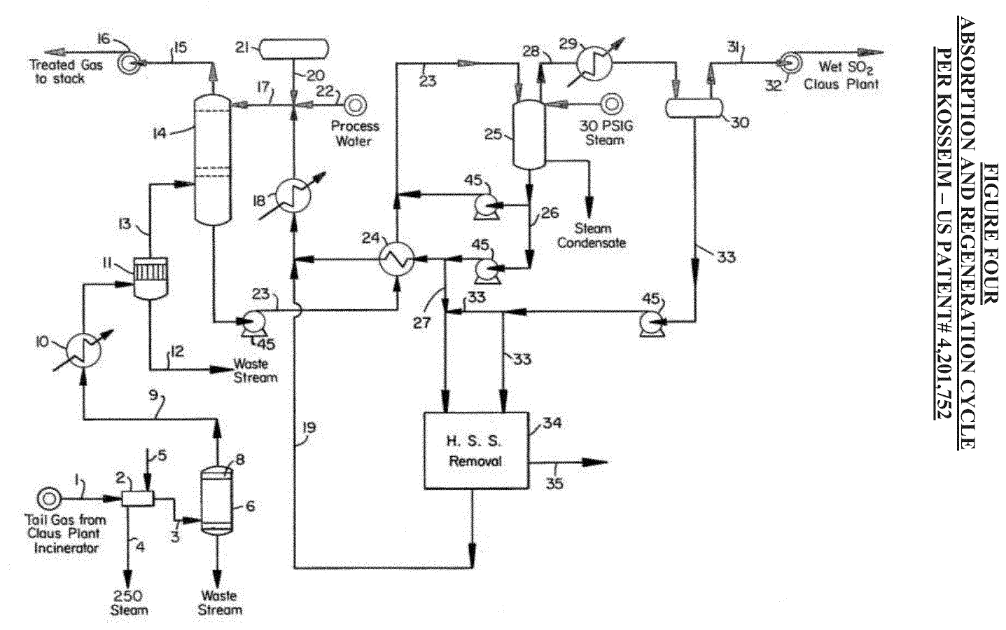

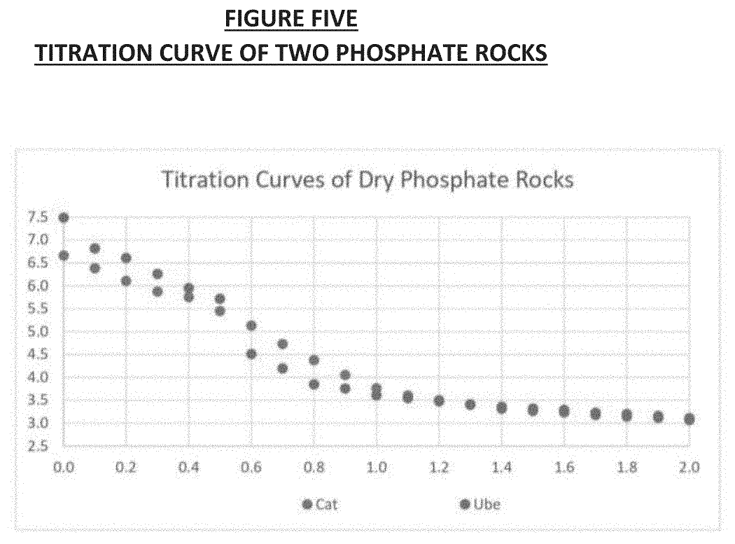

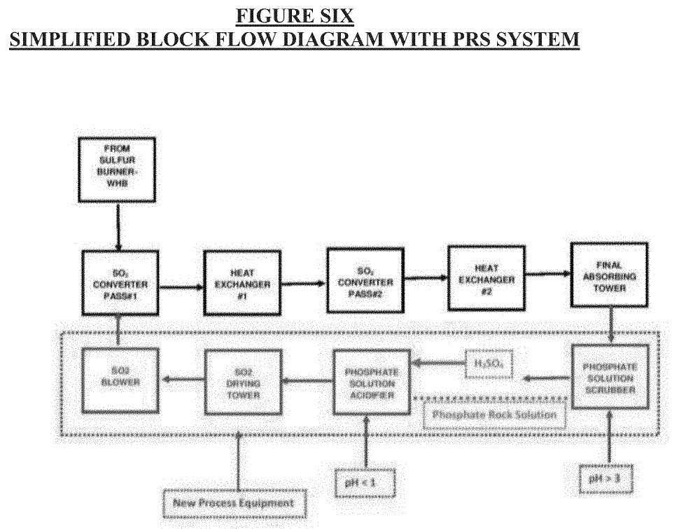

However, the preferred embodiment of this invention is shown in FIG. 6 with the phosphate rock scrubber solution system scrubbing the off-gas from a sulfuric acid plant of a phosphate fertilizer complex. That sulfur dioxide laden phosphate rock solution is then processed by acidification, as previously described.

### REFERENCE CITATION

### US Patents

U.S. Pat. No. 3,259,459 Moller et. al.
U.S. Pat. No. 3,477,815 Miller et. al,
U.S. Pat. No. 3,904,735 Atwood et. al.
U.S. Pat. No. 4,795,620 Heisel et. al.
U.S. Pat. No. 5,019,361 Hakka et. al.
U.S. Pat. No. 5,108,731 Schoubye et.al.
U.S. Pat. No. 5,439,664 Heisel et. al.
U.S. Pat. No. 5,851,265 Burmaster et. al.

### Literature Citations

(1) Not applicable.
(2) Rochester, Colin: Acidity Functions; Academic Press; London; New York, 1970
(3) Schmidt, Max; 1972: “Fundamental Chemistry of Sulfur Dioxide Removal and Subsequent Recovery via Aqueous Scrubbing”; International Journal of Sulfur Chemistry: Part B; Volume 7; pages 11-19.
(4) Johnstone, H. F. and P. W. Leppla; “The Solubility of Sulfur Dioxide at Low Pressures; Journal of the American Chemical Society; Volume 56; November 1934; pages 2233-38.

### DESCRIPTION OF FIGURES

Figure One: Standard Double Absorption-Contact Sulfuric Acid Process Figure Two: Equilibrium SO₂ to SO₃ for a Single Pass Absorption System

Figure Three: pH of Sulfur Dioxide Species in Solution

Figure Four: Typical Absorption—Regeneration per Kosseim

Figure Five: Titration Curve of Phosphate Rock

Figure Six: Block Flow Diagram of Two Converter Pass (+PRS) System

1. A phosphate rock solution is used to scrub a gas stream containing sulfur dioxide, capturing this sulfur dioxide in the aqueous stream.

2. This sulfur dioxide gas stream emanates from the tail gas stream exiting a sulfuric acid plant.

3. This sulfur dioxide gas stream emanates from a variety of sources, including a coal-fired power plant.

4. The phosphate rock solution which contains the sulfur dioxide as either sulfite or bi-sulfite ions is acidified with sulfuric acid and thus lowers the pH of solution in a controlled manner and thereby releasing sulfur dioxide as a gas stream.

5. This sulfur dioxide gas is then dried and compressed and enters the contact section of a sulfuric acid plant.

6. This highly concentrated sulfur dioxide stream can be fed to a Claus plant where elemental sulfur is produced.

7. As an alternate, this enriched sulfur dioxide gas stream can be admitted to a paper and pulp processing plant.
